(19) United States
(12) Patent Application Publication
(10) Pub. No.: US 2015/0058078 A1
(43) Pub. Date: Feb. 26, 2015

(54) RULE TO CONSTRAINT TRANSLATOR FOR BUSINESS APPLICATION SYSTEMS

(71) Applicant: Microsoft Corporation, Redmond, WA (US)

(72) Inventors: Michael Ehrenberg, Seattle, WA (US); Samuel Skrivan, Seattle, WA (US); Wolf Kohn, Seattle, WA (US)

(73) Assignee: Microsoft Corporation, Redmond, WA (US)

(21) Appl. No.: 14/010,077

(22) Filed: Aug. 26, 2013

(51) Int. Cl. G06Q 10/04

(52) U.S. Cl. CPC G06Q 10/04
USPC 705/7.31

(57) ABSTRACT

A collection of rules are translated into a mathematical constraint model for a business application to effectively encode the knowledge, apply the model, and suggest results in a highly consistent, highly performant manner. An integrated feedback mechanism enables the system to learn weights and relationships between related rules that may not be obvious to the knowledge workers and to detect the emergence of new factors for adjustments to the model. Constraints that may affect the outcome of the optimization may be considered instead of all constraints allowing the optimizer to run much more quickly. Parallelism may be enabled allowing execution of multiple optimization processes to evaluate multiple scenarios. Furthermore, outcome of the optimizations may be explained back to the user by providing the constraints that were considered.

### BACKGROUND

Businesses constantly make decisions that impact their profitability, customer satisfaction and growth. How much of a product to manufacture when and where? How much of a product to order and from which supplier? Where to deploy resources? Increasingly, these decisions are impacted by multiple variables—demand, supply, price, delivery time—and those variables can be very dynamic. Finding the optimal choices in time to be effective can be beyond human capabilities. Software, using complex mathematical constraint models, may provide the opportunity to solve these optimization challenges quickly, consistently, and at scale. Connecting constraint optimization to core business applications like Enterprise Resource Planning (ERP), Customer Relationship Management (CRM) or Supplier Relationship Management (SRM), enables the software recommended choices to be directly coupled to the business process flow and transaction systems.

It is rare, however, for the people that understand which factors impact business choices to also understand the mathematics of constraint optimization. They do however understand their business and are able to describe their decisions in the form of rules. In optimizing forecast, sales, marketing, and inventory, rule based systems may be utilized. However, translation of the business user's rules into query constraints used by the system is an existing challenge.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to translating a collection of rules into a mathematical constraint model in a business application system to effectively encode needed knowledge such that the system can apply the model and suggest results in a highly consistent, highly performant manner. By integrating a feedback mechanism the system may be enabled to learn weights and relationships between related rules that may not be obvious to the knowledge workers and to detect the emergence of new factors that may necessitate adjustment to the model. In some examples, constraints that may affect the outcome of the optimization may be considered instead of all constraints allowing faster optimization. Furthermore, parallelism may be enabled allowing execution of multiple optimization processes to evaluate multiple scenarios. In other examples, outcome of the optimizations may be explained back to the user by providing the constraints that were considered.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example implementation scenario for rule-to-constraint translation according to some embodiments;

FIG. 2 is a conceptual diagram illustrating another example implementation scenario for rule-to-constraint translation according to other embodiments;

FIG. 3 illustrates an example architecture for a state abstract machine (SAM) to perform rule-to-constraint translation according to embodiments;

FIG. 4 illustrates a block diagram of a business application system using a SAM according to embodiments in order optimization;

FIG. 5 illustrates a block diagram of an example system employing a Pareto game to describe how the predicted states for one product interact with the other product states;

FIG. 6 is a simplified networked environment, where a system according to embodiments may be implemented;

FIG. 7 is a block diagram of an example computing operating environment, where embodiments may be implemented; and

FIG. 8 illustrates a logic flow diagram for a process of rule-to-constraint translation according to embodiments.

### DETAILED DESCRIPTION

As briefly described above, a collection of rules may be translated into a mathematical constraint model in a business application system to effectively encode needed knowledge such that the system can apply the model and suggest results in a highly consistent, highly performant manner. By integrating a feedback mechanism the system may be enabled to learn weights and relationships between related rules that may not be obvious to the knowledge workers and to detect the emergence of new factors that may necessitate adjustment to the model.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components for providing business application services that may include rule-to-constraint translation such as Enterprise Resource Planning (ERP), Customer Relationship Management (CRM), or Supplier Relationship Management (SRM) platforms. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

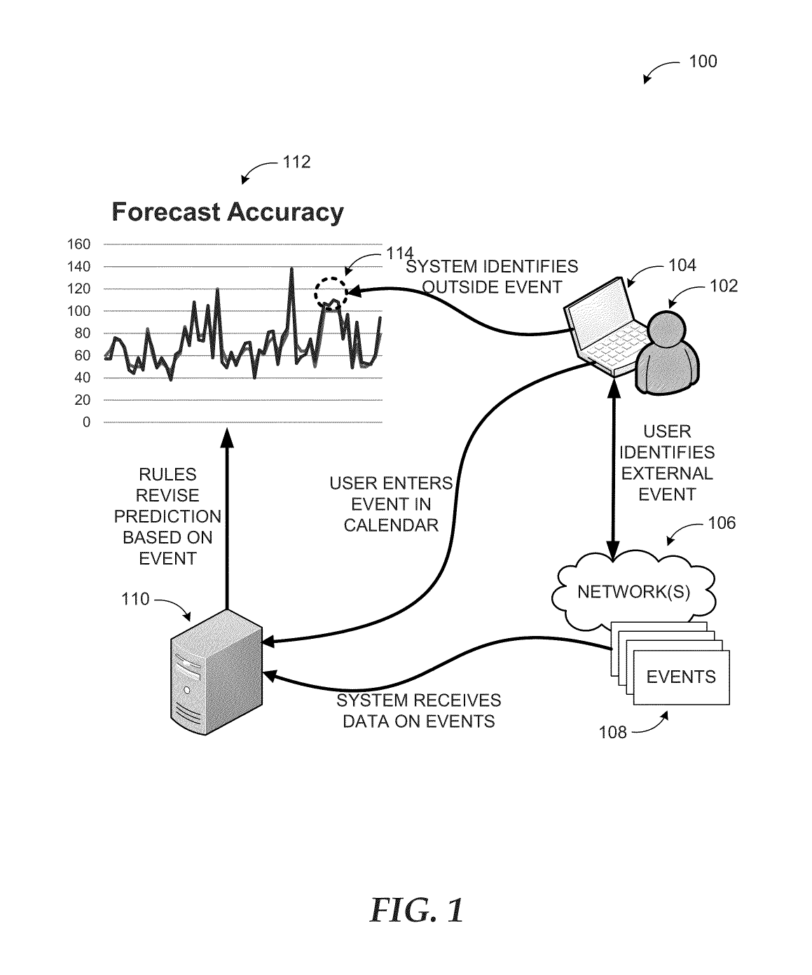

FIG. 1 is a conceptual diagram illustrating an example implementation scenario for rule-to-constraint translation according to some embodiments.

Order forecasting is one of many example components that may be found in a business application system such as an ERP system. Accurate ordering based on predicted demand may have an impact on inventory, sales, and even marketing efforts. Thus, an optimal ordering system processes predicted demand, risk, and parameters generated by a forecaster and develops recommendations for new orders.

The ability to let knowledge workers express the factors in simple, human readable rules—for example, IF WEATHER IS HOT, INCREASE ORDER FOR ICED TEA BY Y % and then have the system translate the collection of rules into a mathematical constraint model may be valuable for the business to effectively encode the needed knowledge, and the system to apply the model and suggest results in a highly consistent, highly performant manner. Moreover, integrating a feedback mechanism may enable the system to learn weights and relationships between related rules that may not be obvious to the knowledge workers and to detect the emergence of new factors that necessitate adjustment to the model.

Diagram 100 shows an example scenario where forecast accuracy 112 may be adjusted/improved based on identification of an external event that may affect demand. External events such as sports events, holidays, major gatherings (e.g., conventions), and comparable ones may affect shopping behavior and thereby demand in businesses. The effect of external events may be different based on the event, type of business or product, or even timing. For example, a major sports event may increase demand on particular products in the summer, while a similar sports event may increase demands on other products in the winter. Similarly, a convention of engineers may have a different impact on product demand in the local area compared to a convention of bikers.

An optimal ordering system according to embodiments may employ rules to predict demand. Rules in form of logic expressions may be converted to mathematical expressions (constraints) and applied to queries that can be processed by the business application system (e.g., ERP system). As shown in the diagram, a user 102 may identify an event among multiple events 108 advertised or otherwise accessible over one or more networks 106 and enter the event into a calendar through their client device 104. The calendar may be maintained by a system (represented by the server 110) in conjunction with the ERP system. Alternatively or in addition, the system may also receive information about the events 108 independently from the user's entry. The system may analyze the event(s) (their type, timing, expected population increase, etc.) and revise a demand prediction for different products or services based on the event using rules. The system may also devise new rules based on the event according to other embodiments. The results may then be used to enhance forecast accuracy 112 as shown by the change 114 based on the identified event.

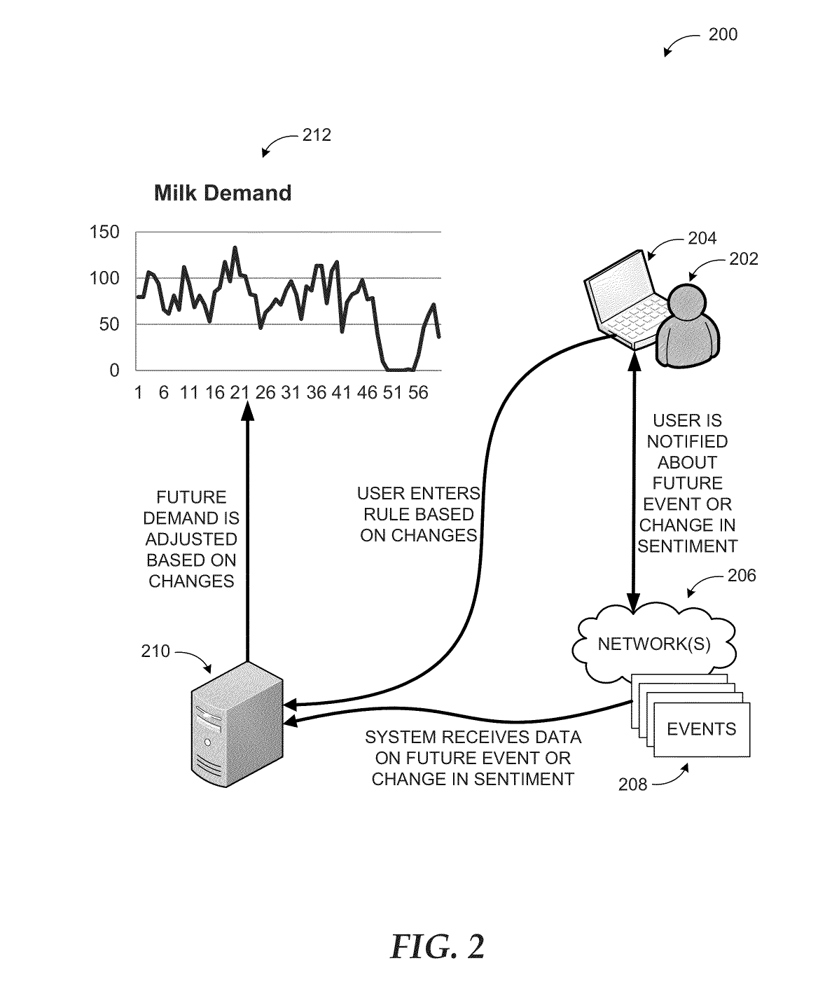

FIG. 2 is a conceptual diagram illustrating another example implementation scenario for rule-to-constraint translation according to other embodiments.

In many cases, rules may react to signals from the real world. Weather, traffic, large events are examples of conditions that may impact demand. Available inventory, location, and storage capacity may affect the supply side. Transaction history may provide a representative base. A mechanism to gather data about these real world conditions and translate them into signals that can be fed into the constraint model is a major component in translating human understanding of business rules into an operational software-based optimization mechanism to drive business results.

In addition to major events and weather conditions, changes in public sentiment may also be factors impacting demand. Thus, a successful forecasting system may need to take into consideration these and other factors for accurate prediction. The example scenario illustrated in diagram 200 shows how demand on milk 212 can be affected and predicted based on external events and/or changes in sentiment. Similar to the discussion in conjunction with FIG. 1, external events 208 or changes in sentiment may be detected by a user 202 or directly by the system. In the example scenario, Milk Day may be coming up as detected from a calendar and expected to increase demand on milk sales. On the other hand, a group may call for a boycott of dairy products around the same time, which may confuse consumers and have the opposite effect.

User 202 may enter a new rule based on the detected changes through their client device 204 and server 210 may process the rules and adjust future demand based on the changes leading to a more accurate milk demand prediction.

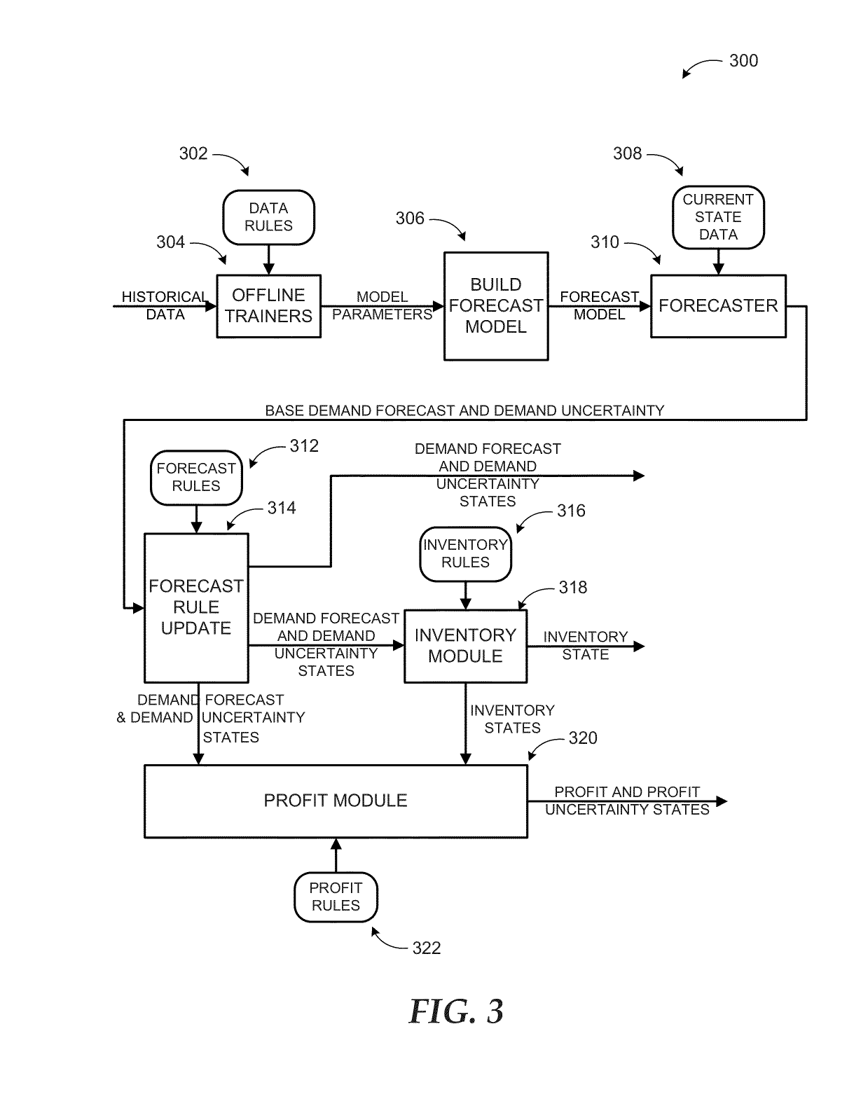

FIG. 3 illustrates an example architecture for a state abstract machine (SAM) to perform rule-to-constraint translation according to embodiments.

Rule-to-constraint translation according to some embodiments may be implemented as software, hardware, or a combination thereof as part of a rules based optimal ordering system. A rule-to-constraint translator may take the rules, which may be expressed as logical expressions, and convert them to mathematical expressions.

Two examples of basic conversions from logical expressions to mathematical expressions may include xΛy=xy and xVy=x+y−xy. While converting the rules (logical expressions) to constraints (mathematical expressions), the rule-to-constraint translator may also collect the parameters used in these expressions. Using the parameters, the system may limit consideration of the rules to those that may affect the outcome thereby optimizing the computation process. A real time optimal ordering system may include a real time algorithm that processes the predicted demand, risk and parameters generated by the forecaster and develops recommendations for the new orders.

Diagram 300 shows a SAM according to some embodiments that includes offline trainers 304 that are arranged to receive historical data from one or more business applications, for example, point of sale data, orders, inventory data, etc. Offline trainers 304 may learn from this data in form of parameters using data rules 302. The data rules 302 may include rules such as “If missing more than half period of data, simulate point of sale/orders and integrate.” The parameters are used to build a forecast model 306, for example, generalized Kalman, probabilistic differential inclusion, or other techniques. The forecast model 306 is used by forecaster 310 to generate demand forecasts with input from the current state data 308 such sale data and orders.

The base demand forecast and demand uncertainty from the forecaster 310 may be adjusted at a forecast rule update module 314 based on forecast rules 312 supplied by end users. Examples of the forecast rules 312 may include the effects of local sporting events, weather events, traffic, etc. Forecast rules upgrade module 413 provides updated demand forecast and demand uncertainty states to an inventory module 318 to suggest inventory levels. Inventory rules 316 may be used by the inventory module 318 as well, such as spoilage, slippage etc. The updated demand forecast and demand uncertainty states along with inventory state information from the inventory module 318 may be used by a profit module 320 with the addition of profit rules 322 to generate profit and profit uncertainty states to be used by one or more business applications. The demand forecast and demand uncertainty states may also be provided directly to a business application.

The following are some illustrative examples of forecast rules 312. If demand varies by week, rules may be used to reflect days of the week such as “If ordering for M/T/W (and no event in that time), use only historical M/T/W. data to build the forecast”. Rules may also be developed for specific events such as “If ordering for a time period in which an event will occur, use historical data for that event to build the forecast,” “If ordering for a time period in which the 4th of July will occur, increase the forecast for picnic-type items (charcoal, lighter fluid, matches, . . . ),” “If ordering for a time period for which there will be a football event, increase the forecast for “tail-gating” items.”

Rules may further be developed for neighborhood specialization such as “If ordering for a Friday and in a predominately Catholic neighborhood, increase the forecast for fish meals and decrease the forecast for chicken,” “If ordering for a Friday and in a predominately Jewish neighborhood, increase the forecast for challah.” Example weather rules may look like “If ordering for a Friday, Sat., Sunday and snow is in the weather prediction, increase the demand forecast for hot chocolate, soup, flashlights,” “If hot weather is predicted, increase the demand forecast for cold tea, cold coffee drinks, and decrease the demand forecast for hot beverages.” In an example system each of the rules such as the ones above may be assigned weights in determining ordering based on impact to order performance.

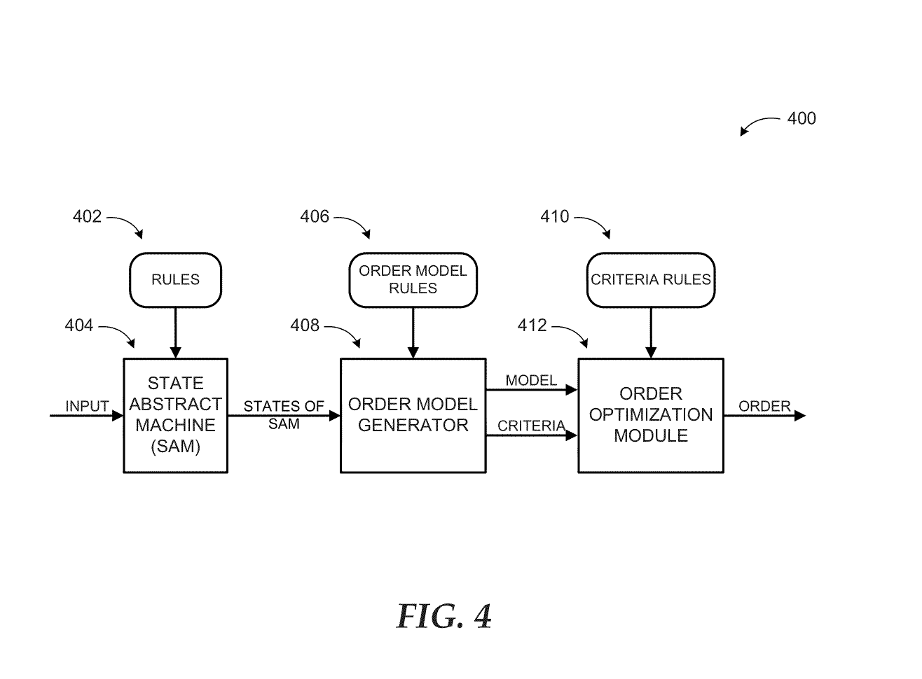

FIG. 4 illustrates a block diagram of a business application system using a SAM according to embodiments in order optimization.

Diagram 400 shows an example system, where SAM 404 receiving input (e.g., historical data) and rules 402 generates states of SAM such as demand forecast states and feeds an order model generator 408. The order model generator 408 may also receive order model rules 406 and generate a model for order generation. Example order model rules may include probabilistic dynamic rules, a control Markov chain, and comparable rules that affect the predictions of the order model generator 408. The order model generator 408 may also generate criteria and a dynamic model for order generation.

An order optimization module 412 may receive criteria rules 410 such as rules for setting Q and R parameters for an LQ tracker or parameters for other kinds of models such as Markov Chain Model, and apply the rules to the order model and criteria received from the order model generator 408. The order optimization module 412 may generate orders, which may be provided to one or more business applications, for example, through a cloud based ordering system to vendor systems.

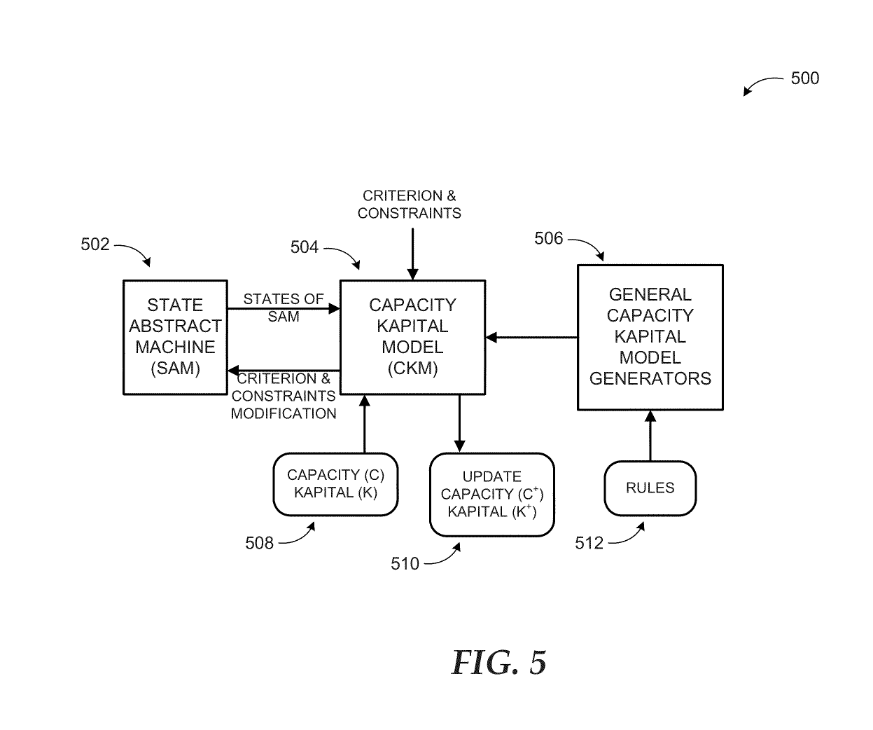

FIG. 5 illustrates a block diagram of an example system employing a standard synchronization between state machines to describe how the predicted states for one product interact with the other product states.

Diagram 500 describes how the predicted states for one product interact with the other products' states in an example implementation. The interaction is represented by the Capacity “Kapital” Model (CKM) 504. Each SAM 502 will synchronize with the CKM 504 to optimize all products' states.

The CKM 504 may be generated by general CKM generators 506 based on game rules 512 such as Pareto, Nash and standard synchronization of state machines. Capacity (C) and Kapital (K) values 508 may be received for the CKM 504 from cloud sources and updated values (C⁺ and K⁺) 510 may be provided back to the cloud sources in some examples. One or more criteria and constraints may also be provided to the CKM 504. SAM 502 may provide SAM states to the CKM 504 and receive the criteria and constraint modification from the CKM 504 as part of the synchronization.

The example scenarios and schemas in FIG. 1 through 5 are shown with specific components, rules, events, and configurations. Embodiments are not limited to systems according to these examples. Employing a rule-to-constraint translation in a business application system may be implemented in configurations employing fewer or additional components in applications and user interfaces. Furthermore, the example schema and components shown in FIG. 1 through 5 and their subcomponents may be implemented in a similar manner with other values using the principles described herein.

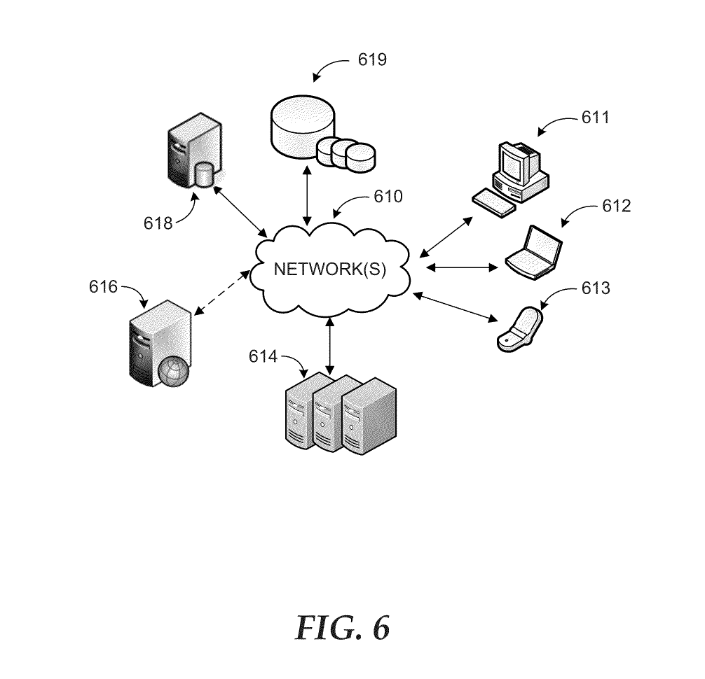

FIG. 6 is an example networked environment, where embodiments may be implemented. Rule-to-constraint translation for a rule based optimization system may be implemented via software executed over one or more servers 614 such as a hosted service. The platform may communicate with client applications on individual computing devices such as a smart phone 613, a laptop computer 612, or desktop computer 611 (‘client devices’) through network(s) 610.

Client applications executed on any of the client devices 611-613 may facilitate communications via application(s) executed by servers 614, or on individual server 616 in providing users access to CRM, ERP, or SRM services such as forecasting, sales management, marketing, and similar ones. A SAM module executed by the service may translate rules in form of logical expressions to mathematical expressions allowing the system to only consider constraints that affect the outcome and thereby enhancing the optimization. Updates or additional data associated with the rule-to-constraint translation may be stored in data store(s) 619 directly or through database server 618 associated with the business application.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to provide rule-to-constraint translation. Furthermore, the networked environments discussed in FIG. 6 are for illustration purposes only. Embodiments are not limited to the example applications, modules, or processes.

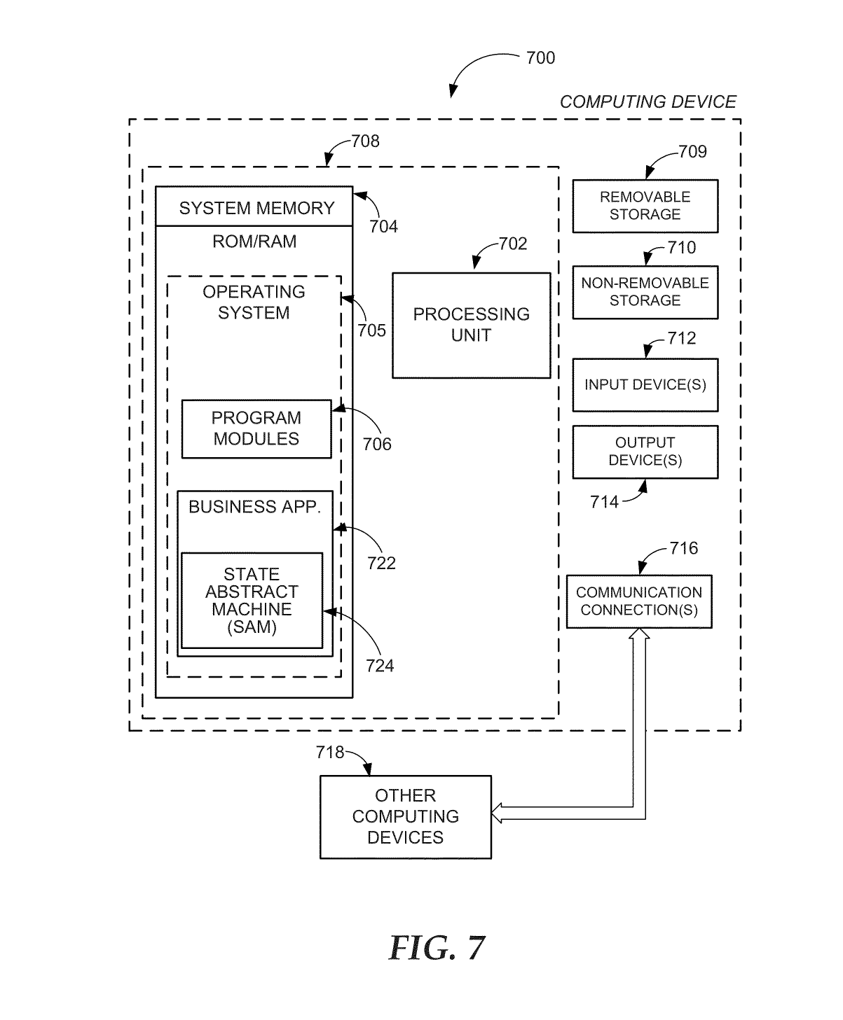

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be any computing device executing rule-to-constraint translation according to embodiments and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as program modules 706, business application 722, and a state abstract machine (SAM) module 724.

The business application 722 may be part of a CRM, ERP, SRM, or similar service and perform one or more aspects of the service such as forecasting, which may include rule based optimal ordering. The business application 722 may operate in conjunction with the SAM module 724 to simplify optimization by translating the rules to constraints before optimization and taking into consideration constraints that may affect the outcome of the optimization. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM. ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, an optical capture device for detecting gestures, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, web servers, and comparable devices. Communication connection(s) 716 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

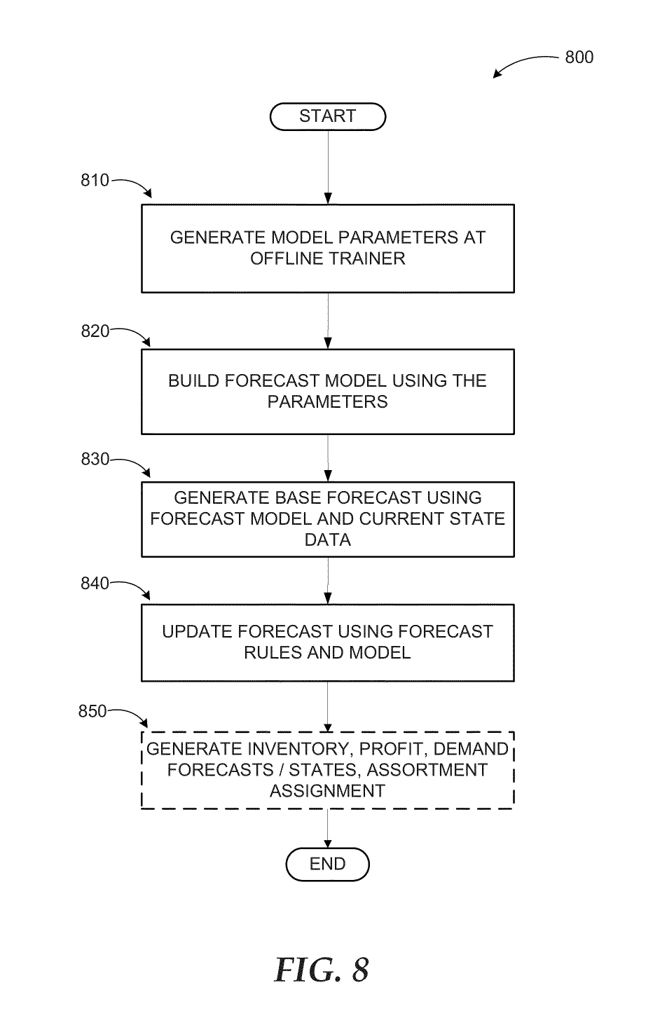

FIG. 8 illustrates a logic flow diagram for a process of rule-to-constraint translation according to embodiments. Process 800 may be implemented in conjunction with an optimization module within a business application system.

Process 800 begins with operation 810, where an offline trainer generates forecast model parameters by learning from historical data based on data rules. The model parameters is used to build a forecast model such as generalized Kalman, probabilistic differential inclusion, or comparable ones at operation 820. A forecaster may use the forecast model and current state data to generate base forecast and uncertainty of the base forecast (e.g., demand forecast) at operation 830.

At operation 840, the forecast is updated based on forecast rules, non-exhaustive examples of which are provided above. The updated forecast may be used to generate inventory state using inventory rules or profit state using profit rules in one or more additional modules. The demand forecast may also be provided directly to business applications that may use the information for various purposes at optional operation 850.

The operations included in process 800 are for illustration purposes. A rule-to-constraint translator may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for employing rule-to-constraint translation in forecast optimization, the method comprising:
generating one or more model parameters at offline trainers based on historical data and one or more data rules;
building a forecast model based on the model parameters;
generating a base forecast using the forecast model based on current state data; and
updating the base forecast based on one or more forecast rules.

2. The method of claim 1, wherein the forecast is for demand prediction in a business environment.

3. The method of claim 2, further comprising:
generating one or more of an inventory state based on the updated demand forecast and inventory rules and a profit state based on the updated demand forecast and profit rules.

4. The method of claim 3, further comprising:
providing one or more of the updated demand forecast, the inventory state, and the profit state to a business application.

5. The method of claim 2, further comprising one of:
automatically generating the one or more forecast rules and receiving the one or more forecast rules from a user.

6. The method of claim 1, further comprising:
enabling parallel execution of multiple scenarios in forecast optimization.

7. The method of claim 6, further comprising:
employing the one or more forecast rules in providing feedback to a user about the forecast optimization.

8. The method of claim 1, wherein the historical data includes one or more of point of sale data, orders, and inventory data.

9. The method of claim 1, wherein the forecast model includes one of a generalized Kalman model and a probabilistic differential inclusion.

10. The method of claim 1, wherein the business environment includes one of an Enterprise Resource Planning (ERP) system, a Customer Relationship Management (CRM) system, and a Supplier Relationship Management (SRM) system.

11. A computing device configured to employ rule-to-constraint translation in demand forecast optimization, the computing device comprising:
a memory;
a processor coupled to the memory, the processor executing a state abstract module (SAM) in conjunction with instructions stored in the memory, wherein the SAM is configured to:
generate one or more model parameters at offline trainers based on historical data and one or more data rules;
build a demand forecast model based on the model parameters;
generate a base demand forecast using the forecast model based on current state data;
update the base demand forecast based on one or more forecast rules;
generate one or more of an inventory state based on the updated demand forecast and inventory rules and a profit state based on the updated demand forecast and profit rules; and
provide one or more of the updated demand forecast, the inventory state, and the profit state to a business application.

12. The computing device of claim 11, wherein the SAM is further configured to:
provide demand forecast states to an order model generator to generate an order model and one or more criteria for order generation using order model rules.

13. The computing device of claim 12, wherein the order model generator is further configured to:
receive one or more criteria rules; and
apply the criteria rules to the order model and criteria received from the order model generator to generate orders.

14. The computing device of claim 13, wherein the SAM is further configured to:
assign weights to the one or more forecast rules based on each forecast rule's impact on order performance.

15. The computing device of claim 14, wherein the SAM is further configured to:
order the forecast rules based on the weights.

16. The computing device of claim 11, wherein the SAM is further configured to:
one of automatically generate and receive the forecast rules based on one or more of a timing of the demand, an external event, a weather condition, and a detected change in consumer sentiment.

17. The computing device of claim 11, wherein the SAM is further configured to:
display forecast optimization results to a user along with the forecast rules; and
enable the user to execute multiple optimization scenarios in parallel.

18. A computer-readable memory device with instructions stored thereon for employing rule-to-constraint translation in demand forecast optimization, the instructions comprising:
generating one or more model parameters at offline trainers based on historical data and one or more data rules;
building a demand forecast model based on the model parameters;
generating a base demand forecast using the forecast model based on current state data;
updating the base demand forecast based on one or more forecast rules, wherein the forecast rules are one of automatically generated and received from a user;
generating one or more of an inventory state based on the updated demand forecast and inventory rules and a profit state based on the updated demand forecast and profit rules; and
providing one or more of the updated demand forecast, the inventory state, and the profit state to a business application.

19. The computer-readable memory device of claim 18, wherein the instructions further comprise:
generating an order model and one or more criteria based on updated demand forecast states and one or more order model rules; and
applying one or more criteria rules to the order model and criteria to generate orders.

20. The computer-readable memory device of claim 18, wherein the instructions further comprise:
integrating a feedback mechanism to forecast optimization in order to train users about weights and relationships between related forecast rules.
